(19) United States
(12) Patent Application Publication
(10) Pub. No.: US 2007/0203882 A1
(43) Pub. Date: Aug. 30, 2007

(54) Method for efficiently retrieving entity beans in an EJB container

(76) Inventors: Akira Koseki, Ysagamihara-shi (JP); Toshio Suganuma, Yokohama-shi (JP); Hideaki Komatsu, Yokohama-shi (JP)

Correspondence Address: LIEBERMAN & BRANDSDORFER, LLC, 802 STILL CREEK LANE, GAITHERSBURG, MD, 20878, US

(21) Appl. No.: 11/351,543

(22) Filed: Feb. 10, 2006

(51) Int. Cl. G06F 17/30

(52) U.S. Cl. 707/2

(57) ABSTRACT

A method and system are provided for efficiently retrieving an entity bean in an EJB Container. The retrieval of beans is divided into multiple pieces of processing, and each retrieval is executed by an independent thread. There is one main thread and a plurality of auxiliary threads. Each of the auxiliary threads processes data obtained by a prior processing thread based upon a speculative primary key and places the processed data in a queue of a next thread. One of the threads is assigned to store the processed data in associative memory. The main thread uses an actual primary key in conjunction with the data placed in the associative memory to process data. Accordingly, speculative creation of bean instances is performed with independent multiple threads.

### BACKGROUND OF THE INVENTION

1. Technical Field

This invention relates to threaded processing of entity beans in an EJB container. More specifically, the invention relates to use of an access pattern of an entity bean for performing speculative creation of bean instances with independent multiple threads.

2. Description Of The Prior Art

An Enterprise JAVA Bean (EJB) is a JAVA based server side reusable component framework for distributed applications that facilitates centrally managed business logic and declarative deployment. There are two types of EJBs: session beans and entity beans. A session bean is created by a client and in most cases exists only for the duration of a single session. A session bean performs operations on behalf of the client such as calculations or database access. Although session beans can be transactional, they are not recoverable following a system crash. A session bean can either have states or they can be stateless. However, Session Beans do not survive a system shutdown. Session beans also can maintain a conversational state across methods and transactions. The container manages the conversational state of a session bean if it needs to be evicted from memory. A session bean must manage its own persistent data. Each session bean is usually associated with one EJB client. Each session bean is created and destroyed by the particular EJB client that it is associated with. Accordingly, session beans are transient and will not outlive the virtual machine on which they were created.

An entity bean represents persistent data that are maintained in a domain model, as well as methods that act on that data. Or to be more specific, an entity bean exactly maps to a record in your domain model. In a relational database context, there is one bean for each row in a table. This is not a new concept, since this is how object databases have been modeled all along. A primary key identifies each entity bean. Entity beans are created by using an object factory create( ) method. Unlike session beans, entity beans are transactional and are recoverable following a system crash. Entity beans are also implicitly persistent. An EJB object can manage its own persistence, or it can delegate its persistence to its container.

Entity beans always have states which can be persisted and stored across multiple invocations. Multiple EJB Clients may share an entity bean. The lifetime of an entity bean is not limited by the lifetime of the virtual machine within which it executes. A crash of the virtual machine may result in a rollback of the current transaction, but will neither destroy the Entity Bean nor invalidate the references that other clients have to this entity bean. Moreover, a client can later connect to the same entity bean using its object reference since it encapsulates a unique primary key allowing the EJB Bean or its container to reload its state. Entity beans can thus survive system shutdowns.

In an application that uses EJBs, entity beans are retrieved by object finders, and business methods are called to process the retrieved beans. In order to create bean instances in the EJB container, various types of processing is carried out. Such processing may include retrieval of data from a database, conversion of data type, creation and initialization of instances, and management of a bean instance pool. In a program where a large number of database accesses are performed via entity beans, there are many cases where the access pattern of the beans is known in advance. The access pattern may be used to perform speculative creation of bean instances with independent multiple threads. For example, retrieval of a bean may be divided into m segments of processing carried out in a speculative manner with an independent thread for each segment. Each thread associates its results with primary keys, stores them in memory, and then passes them to the next thread. The (m−1)^{th} thread associates its results with primary keys and passes them to the main thread, m. When the main thread is processing, an object finder is called with an actual primary key, and the first through (m−1)^{th} threads perform their processing in a speculative manner by using an estimated primary key. Accordingly, this threaded processing enables the first through (m−1)^{th} thread processing to overlap each other and use the CPU resources more efficiently.

However, when processing is divided into threads, problems may occur. Examples of such problems include deadlock, missing updated values, a bean that does not exist is recognized as existing, and exceptions not being correctly reported. Accordingly, there is a need for a solution that efficiently performs the multi-threaded tasking associated with speculative creation of bean instances.

### SUMMARY OF THE INVENTION

This invention comprises a method and system for efficiently obtaining and processing data from a database.

In a first aspect of the invention, a method is provided wherein data retrieval is divided into multiple pieces of processing. Each retrieval is executed by an independent thread, wherein there is at least one auxiliary thread and one main thread. A processing result of each of the auxiliary threads is associated with a primary key. The result of each of the auxiliary thread is stored in a queue of a next auxiliary thread. The results of a final auxiliary thread is stored in associative memory. The main thread retrieves the associative memory with an actual primary key.

In a second aspect of the invention, a computer system is provided with multiple threads for processing data. The multiple threads include a first thread, at least one auxiliary thread, and a main thread. A process result from the first thread and each of said auxiliary threads is associated with a primary key and stored in a queue of a next auxiliary thread. Associative memory is provided and configured to receive a processing result of a final of the auxiliary threads. The main thread retrieves the associative memory with an actual primary key.

In a third aspect of the invention, an article is provided with a computer readable medium. Instructions are provided in the medium to divide data retrieval into multiple pieces of processing with each retrieval to be executed by an independent thread, including at least one auxiliary thread and one main thread. In addition, instructions are provided in the medium for associating a processing result of each of the auxiliary threads with a primary key and storing the result in a queue of a next auxiliary thread. Results of a final auxiliary thread are stored in associative memory. Finally, instructions in the medium are provided for the main thread to retrieve the associative memory with an actual primary key.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a flow diagram of threaded processing according to the preferred embodiment of this invention, and is suggested for printing on the first page of the issued patent.

FIG. 2 is a flow diagram of threaded processing using a backup queue.

FIG. 3 is a flow chart illustrating a process for purging the associative memory.

FIG. 4 is a flow chart illustrating processing by a common object finder where the cache of bean instances has been implemented.

FIGS. 5A-5C are flow charts illustrating processing of the first auxiliary thread.

FIGS. 6A-6G are flow charts illustrating processing of the second auxiliary thread.

FIGS. 7A-7B are flow charts illustrating retrieval of an entity bean by the main thread.

FIG. 8 is a flow chart illustrating the memory management thread.

FIGS. 9A-9C are flow charts illustrating removal of an entity bean by the main thread.

FIGS. 10A-10C are flow charts illustrating creation of an entity bean by the main thread.

FIGS. 11A-11B are flow charts illustrating transaction commitment processing by the main thread.

### DESCRIPTION OF THE PREFERRED EMBODIMENT

### Overview

There are a variety of methods available to decrease the cost of creating a bean instance within an EJB container. One method utilizes caches for contents of database retrieval. Such caches include caches for created bean instances, caches for bean identifiers, caches for wrappers to wrap calls of a method to bean instances, and transaction caches including high speed caches for bean instances that do not need synchronization between threads and utilize the characteristic of the transaction that the thread context does not change. Another method utilizes a pooling mechanism for bean instances that are not related to a specific entity but are created and pooled in advance. When bean instances are needed, an object is utilized from the pool.

In a program where a large number of database accesses are made via entity beans, there are many cases where the access pattern of a bean is known in advance. For example, in a batch application based on specific input data, beans are created and processed one after another. It is possible to read this input data prior to the processing of application logic and prepare the bean resources in a speculative manner.

### Technical Details

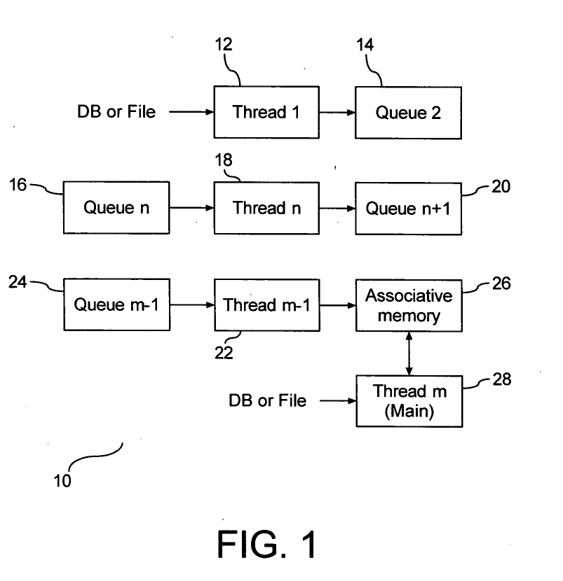

The retrieval of beans based on input read ahead is divided into m pieces of processing, and each retrieval is executed by an independent thread. FIG. 1 is a flow diagram (10) illustrating threaded processing. As shown, the first thread (12) obtains data for processing and stores its results in the queue of the second thread (14). The nth thread (18) extracts the data necessary for its processing from the nth queue (16), associates its processing results with primary keys and stores them in the (n+1)^{th} queue (20). There are a total of m threads. The (m−1)^{th} (22) thread extracts the data necessary for its processing from the (m−1)^{th} queue (24) associates its processing results with primary keys and stores them in associative memory (26). The first through (m−1)^{th} threads conducting their own processing in a speculative way by using estimated primary keys. The main thread (28), m, retrieves the associative memory by using the actual primary keys.

As shown in FIG. 1, multiple non-main threads conduct processing in a speculative manner. The processing of the non-main threads needs to be synchronized. Prior read processing consists of a prior read for retrieval and a prior read for creation, and the difference between them is indicated by a flag. As shown above, the first thread associates the processing results based on prior read input with primary keys and stores them in the queue of the second thread. The first thread also attaches the prior read flag for retrieval of the prior read flag for creation of the entries. Retrieval from the database is performed in this first thread. The n^{th} thread conducts processing based on the results of the prior thread and associates the processing results with primary keys and stores them in the (n+1)^{th} queue. In one embodiment, the process of storing to the associative memory, see step (26), is performed only if there is no entry when the associative memory is retrieved with the primary key. This process of storing to the associative memory prevents loss of updated data processed by the main thread. The main thread, m, retrieves the results of the (m−1)^{th} thread with the primary key. Synchronization is not conducted for receiving and passing these data items and retrieval processing. If there is no retrieval result when the main thread retrieves the results of the (m−1)^{th} thread, the main thread waits until the result to be retrieved appears in the associative memory. In one embodiment, processing may not be applied if an application includes access of beans that are difficult to estimate the primary keys. This supports the main thread for determining the primary key of a bean prior to access.

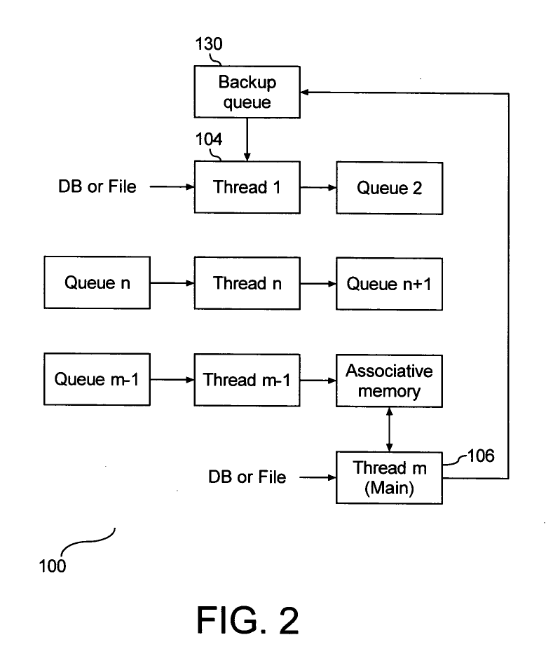

FIG. 2 is a flow diagram (100) illustrating a variation of the flow diagram shown in FIG. 1. As shown herein, the first thread includes a backup queue (130). In one embodiment, a time duration is utilized, and if the result for a primary key is delayed for more than the threshold time duration, the primary key is added to an auxiliary queue of the first thread, i.e. the backup queue, and the main thread (106) continues to wait for the result. The first thread (102) monitors the backup queue (130), and if there is an entry in this queue (130), the entry is given priority and processed first. In one embodiment, if the number of threads is large processing of the backup queue may cost too much. If it is determined that this processing will have a serious effect on execution of the application, the processing of the entity beans is dynamically cancelled.

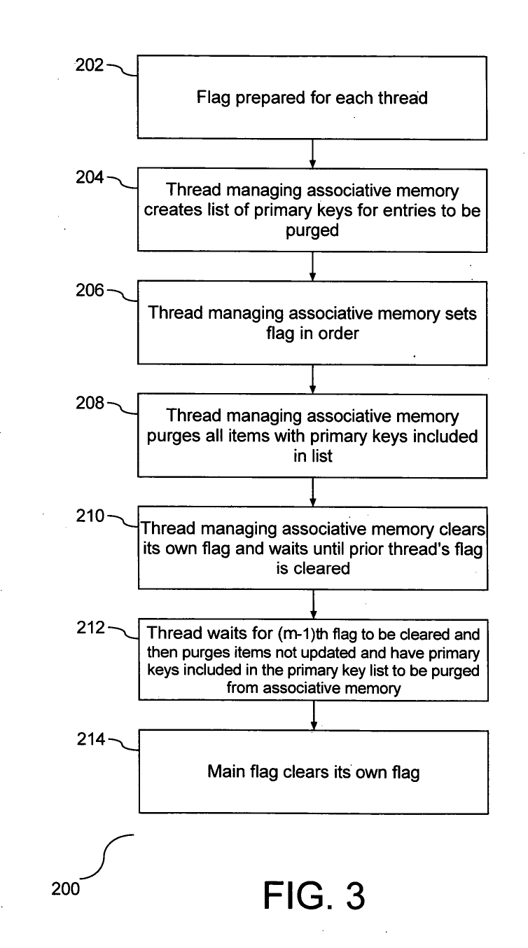

The associative memory has limited capacity, and as such requires management. Maintaining bean resources without any limitation may cause a serious impact on the performance of an application. In one embodiment, data in the associative memory are periodically purged. FIG. 3 is a flow chart (200) illustrating a process for purging the data from associative memory. A flag indicating the execution of a purge is prepared for each thread (202). A thread that manages the capacity of the associative memory at regular intervals decides the entries that should be purged and creates a list of primary keys for those entries (204). This same thread sets the flags of each of the entries in order starting with the first thread and proceeding to the last thread (206). When the flag of the nth thread is set, this thread stores the current processing entry in the queue of the (n+1)^{th} thread, and from the queue entries purges all items with primary keys included in the primary key list of entries to be purged (208). When the flag of the (m−1)^{th} thread is set and after the thread stores the processing entry into the associative memory, the thread clears its own flag and waits until the flag of the (m−2)th thread is cleared (210). When the flag of the main thread, m, is set, the thread waits for the (m−1)^{th} flag to be cleared and then purges items that are not updated and have primary keys included in the primary key list of the entries to be purged from the associative memory (212). In one embodiment, items that are updated after synchronization of the database are also purged. Following step (212), the main thread clears its own flag (214). Accordingly, the main thread's flag manages purging of the associative memory to maintain bean resources within an efficient operating range.

An object finder that retrieves entity beans usually has a cache for bean instances. Independent auxiliary threads perform processing so as to store bean instances in this cache. These auxiliary threads speculatively create primary keys that will be inputs of the main thread, perform a series of processes necessary for creation of bean instances, and store the primary keys in the cache. The main thread calls an object finder using a primary key as a key and after the object finder retrieves beans from the cache efficiently, the main thread processes the business logic using these beans.

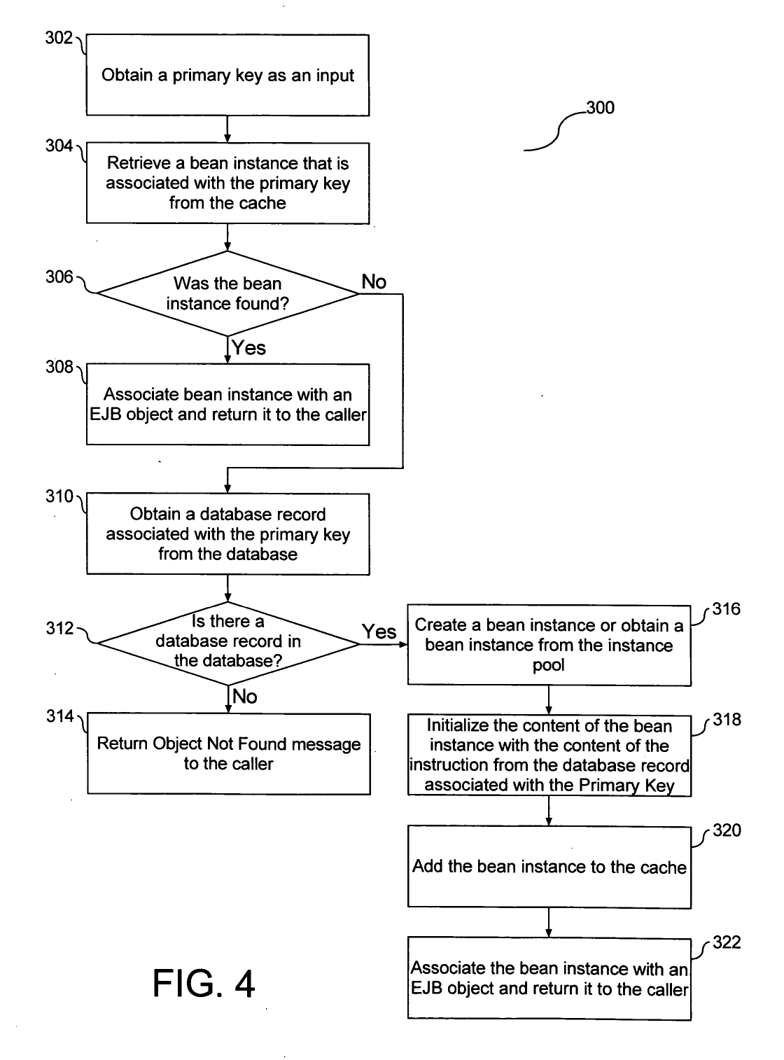

FIG. 4 is a flow chart (300) demonstrating the processing by a common object finder where the cache of bean instances has been implemented. Initially, the main thread obtains a primary key as an input (302), and retrieves a bean instance that is associated with the primary key from the cache (304). A test is then conducted to determine if the bean instance was found in the cache (306). A positive response to the test at step (306) will result in associating the bean instance with an EJB object and returning it to the caller (308). A negative response to the test at step (306) will result in a database record associated with the primary key being obtained from the database (310), followed by another test to determine if there is a database record in the database (312). A negative response to the test at step (312) will result in an object not found message being returned to the caller (314). On the other hand, a positive response to the test at step (312) will result in creating a bean instance or obtaining a bean instance from the instance pool (316), followed by initializing the content of the bean instance with the content of the instruction from the database record associated with the primary key (318). Thereafter, the bean instance is added to the cache (320) and it is associated with an EJB object and returned to the caller (322). The process outlined in steps (302)-(322) is performed by using several auxiliary threads together with a memory management thread.

Each entry in the queue and associative memory has a mark attached thereto to control passing of data between each thread. The following is a list of marks and associated explanations:

| | |
|---|---|
| Not Found | There is no result of a database retrieval by using a |
| | certain primary key |
| Removed | Removal by the main thread has been performed |
| Created | Creation by the main thread has been performed |
| Create Error | An error at the time of creation by the main thread |
| Remove Error | An error at the time of removal from the main thread |
| Find Request | The main thread is requesting the auxiliary threads to |
| | create a retrieve entry |
| Remove | The main thread is requesting the auxiliary threads to |
| Requested | create a removal entry |
| Created | The main thread is requesting that the auxiliary |
| Requested | threads create a creation entry |
| For Find | A retrieve entry is speculatively created |
| For Create | A creation entry is speculatively created |

Each of the above listed marks may be attached to a queue entry.

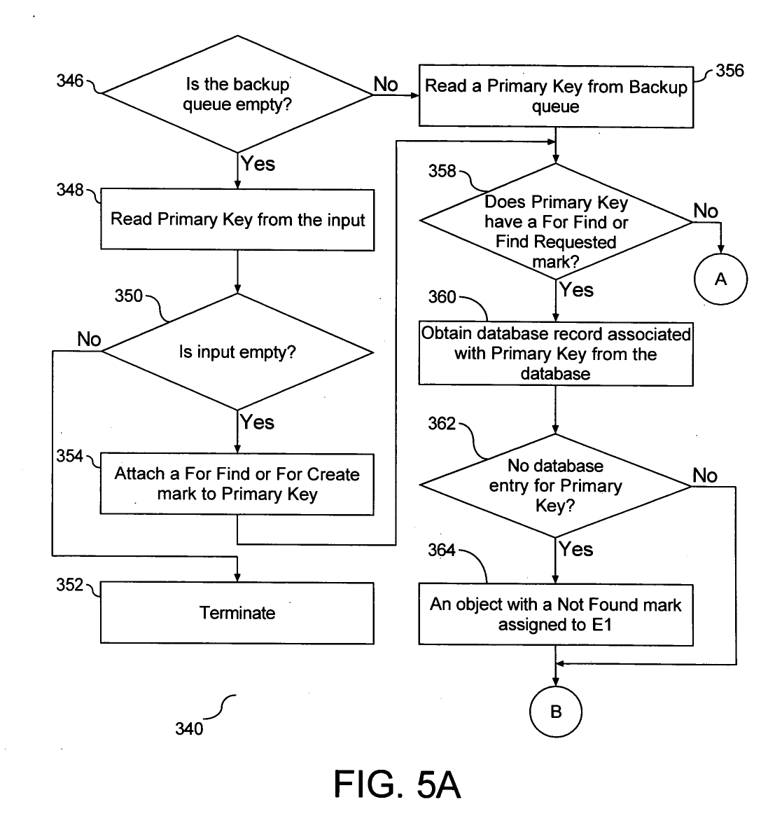

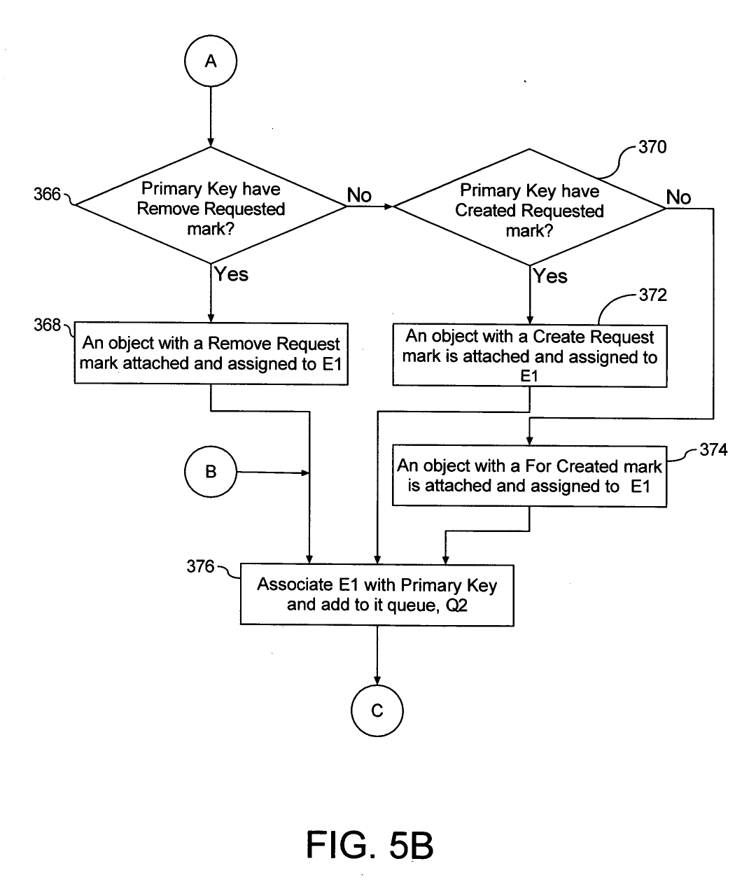

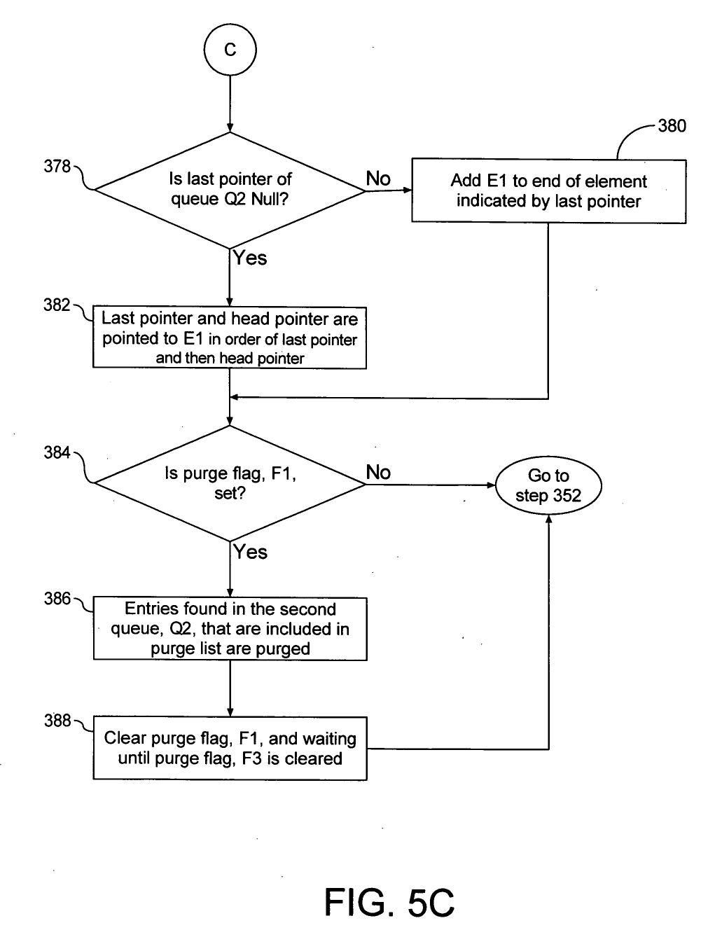

The following figures demonstrate the creation and removal of beans and the commitment of the transaction by the main thread. FIG. 5A is a flow chart (340) illustrating the first auxiliary thread. In one embodiment, it is assumed that the first auxiliary thread knows how the entity bean has been created from an input file, an input database, or input streams. Initially, a test is conducted to determine if a backup queue is empty (346). A positive response to the test at step (346) will result in reading a primary key from the input (348), followed by a subsequent test to determine whether the input is empty (350). A negative response to the test at step (350) terminates the process for the first auxiliary thread (352), while a positive response to the test at step (350) results in attaching either a For Find mark or a For Create mark to the primary key being processed (354) and proceeding to step (358). A negative response to the test at step (352) will result in reading a primary key from the backup queue (356), followed by a subsequent test to determine if the primary key obtained at either step (354) or (356) has a For Find or Find Requested mark (358). A positive response to the test at step (358) results in obtaining a database record associated with the primary key from the database (360). Necessary type conversion is performed and the converted item is regarded as E1 and a For Find or Find Requested mark is attached, respectively. Following step (360), another test is conducted to determine if there is no database entry for the primary key (362). A positive response to the test at step (362) results in an object with a Not Found mark being assigned to E1 (364). If the response to the test at step (362) is negative, E1 is associated with the primary key and added to the second queue, Q2 (376). Following a negative response to the test at step (358), a test is conducted to determine if the primary key has a Remove Requested mark (366). If the response to the test at step (366) is positive, an object with a Remove Requested mark is attached and assigned to E1 (368). On the other hand, if the response to the test at step (366) is negative, a test is conducted to determine if the primary key has a Create Requested mark attached (370). If the response to the test at step (370) is positive, an object with a Create Request is attached and assigned to E1 (372). Finally, if the response to the test at step (370) is negative, an object with a For Create mark is attached and assigned to E1 (374). Followings steps (364), (368), (372), (374), or a negative response to the test at step (362), E1 is associated with the primary key and added to the second queue, Q2 (376). Subsequent to the assignment at step (376), a test is conducted to determine if the last pointer of the second queue, Q2 is NULL (378). A negative response to the test at step (378) results in adding E1 to the end of the element indicated by the last pointer (380). The last pointer is pointed to E1. Similarly, a positive response to the test at step (378) results in pointing both the last and head pointers to E1 in order of the last pointer and then the head pointer (382). Note that the first auxiliary thread updates only the last pointer. Following completion of steps (380) and (382), a test is conducted to determine if the purge flag, F1, is set (384). A positive response to the test at step (384) results in purging entries found in the second queue, Q2, that are included in the purge list (386), followed by clearing the purge flag, F1, and waiting until the purge flag, F3, is cleared (388). Following a negative response to the test at step (384) or completion of step (388), the process returns to step (352) to determine if the backup queue is empty. Accordingly, as shown, the first auxiliary thread is responsible for updating the last pointer.

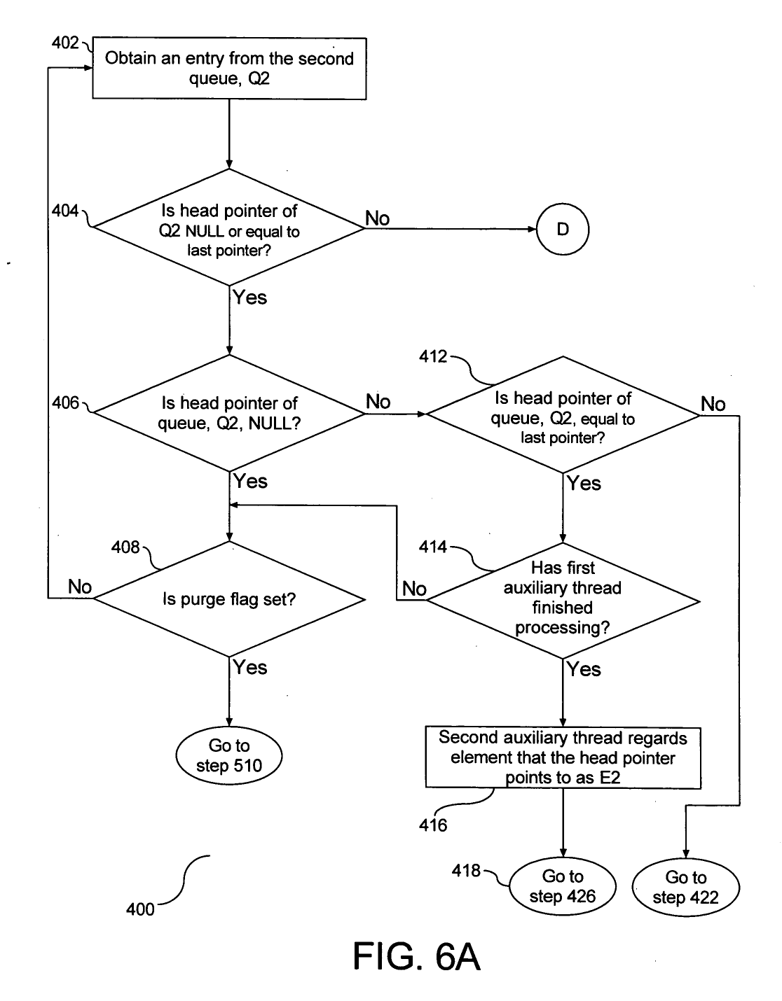

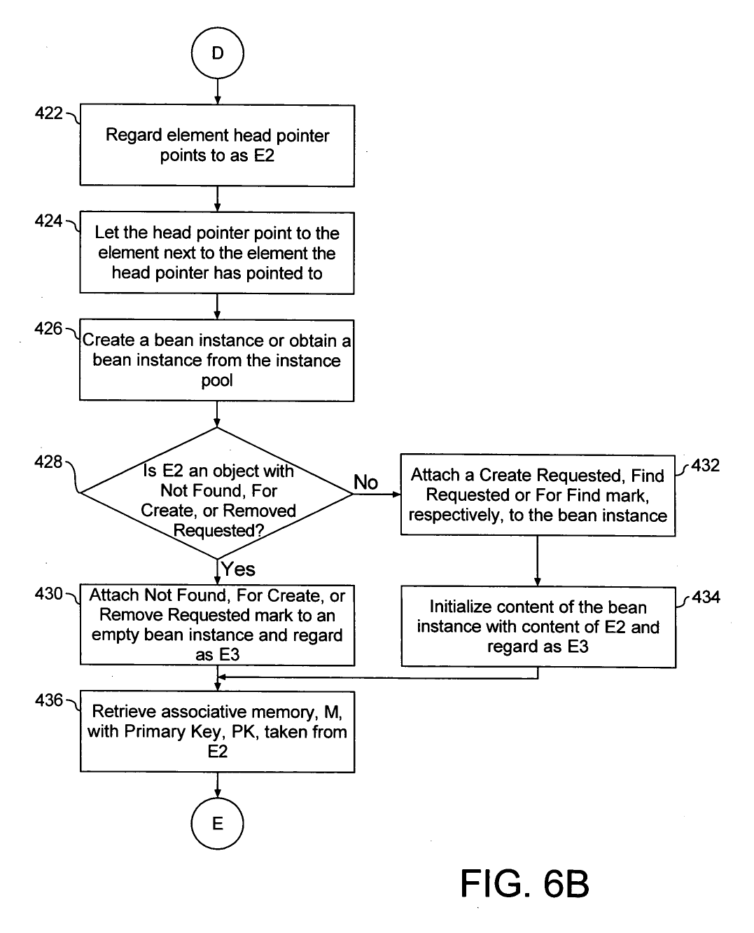

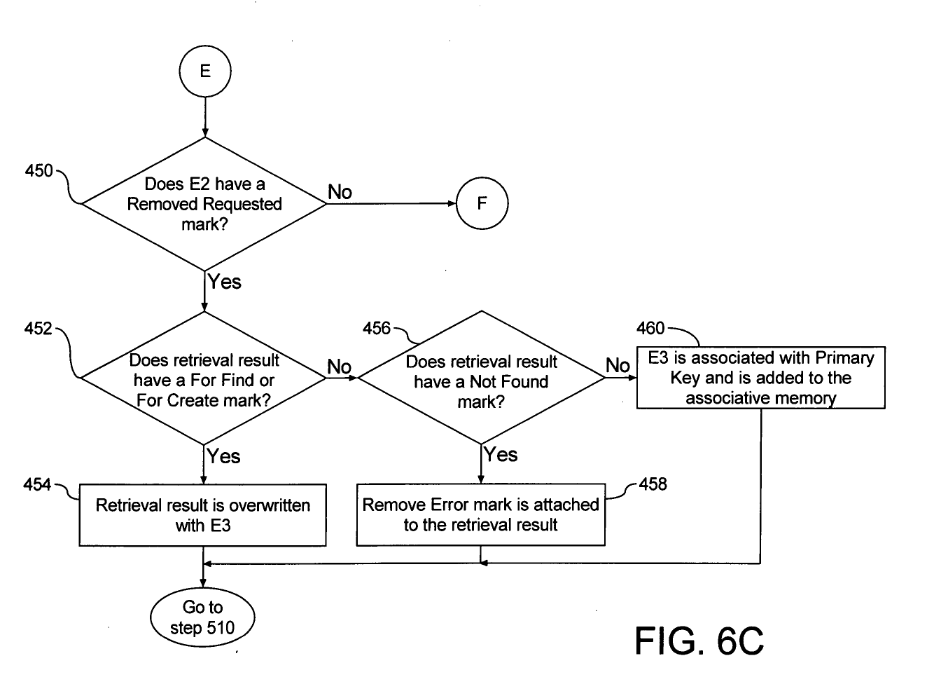

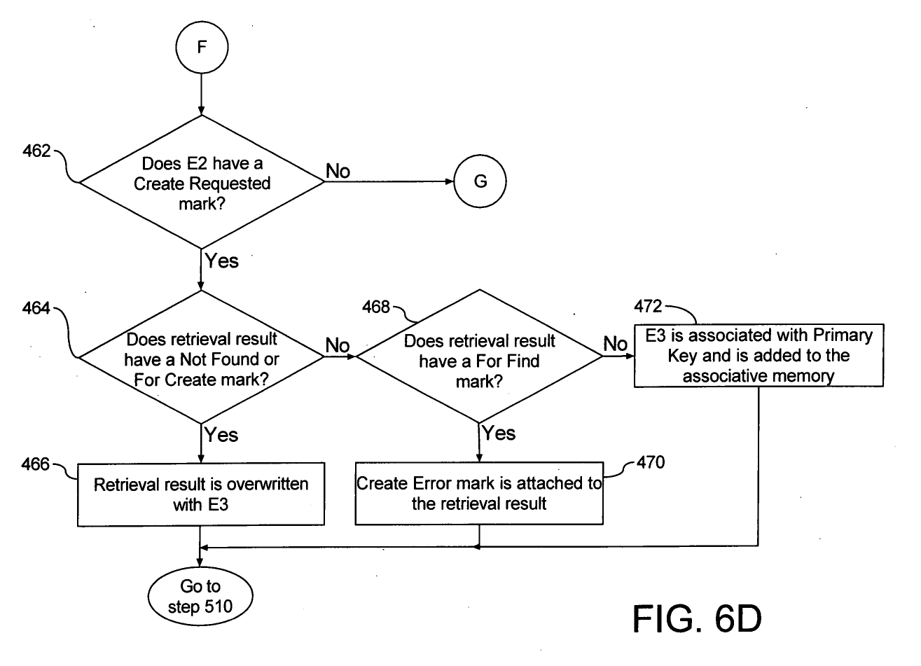

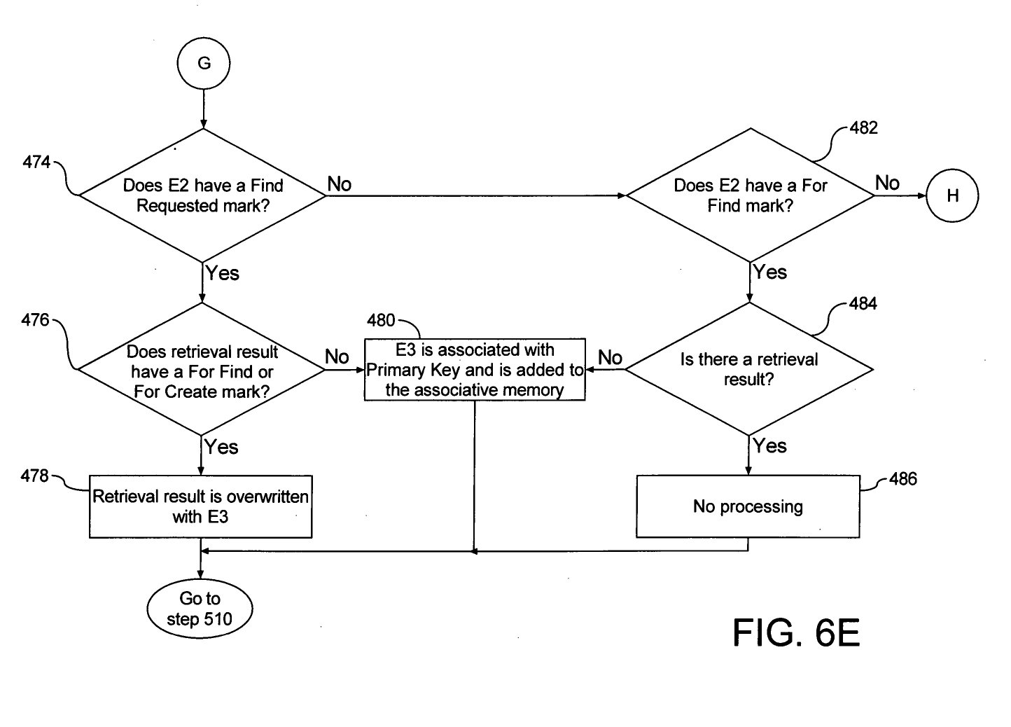

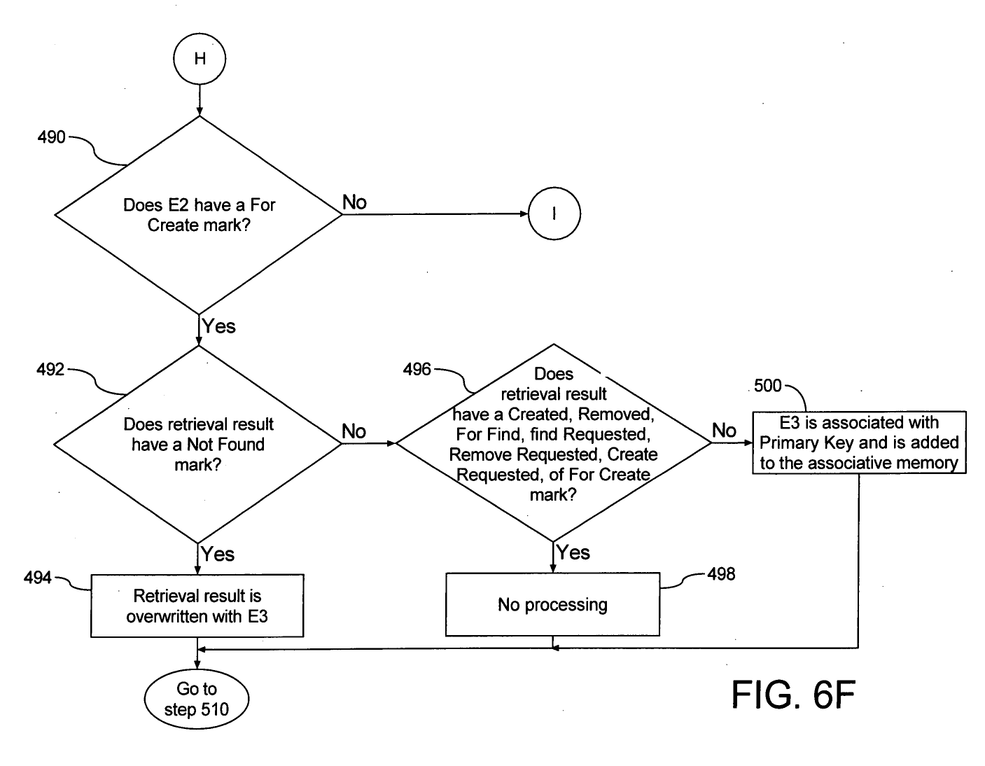

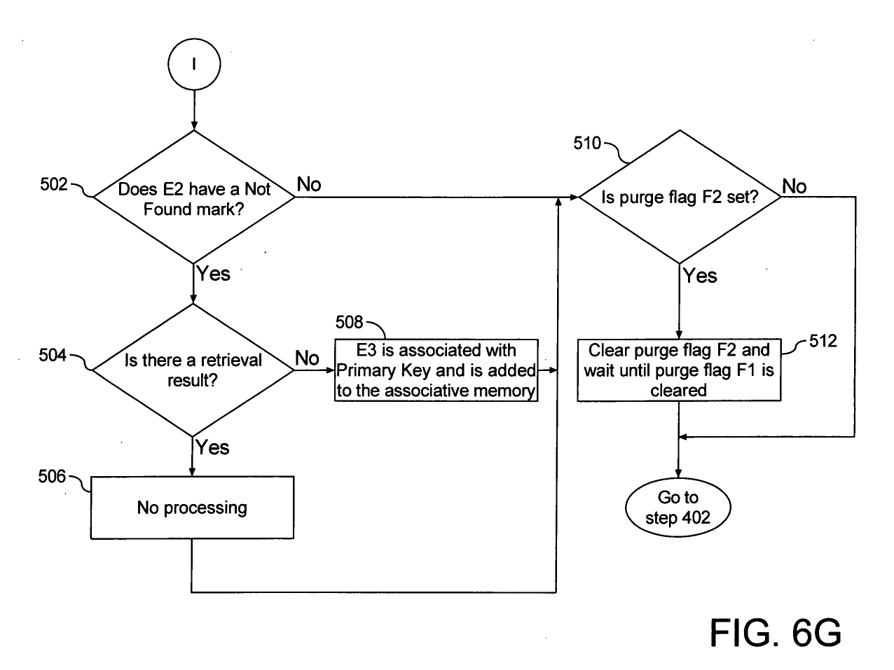

FIG. 6 is a flow chart (400) illustrating the processing performed by a second auxiliary thread. Initially, an entry is obtained from the second queue, Q2, (402). Thereafter, a test is conducted to determine if the head pointer of the second queue, Q2, is null or equal to the last pointer (404). If the response to the test at step (404) is negative, processing of the second auxiliary thread proceeds to step (422). In contract, if the response to the test at step (404) is positive, a subsequent test is conducted to determine if the head pointer of the queue, Q2, is NULL (406). A positive response to the test at step (406) results in a subsequent test to determine if the purge flag is set (408). If the response to the test at step (408) is positive, the processing of the second auxiliary thread proceeds to step (510), otherwise it returns to step (402). A negative response to the test at step (406) will result in a test to determine if the head pointer of the second queue, Q2, is equal to the last pointer (412). A positive response to the test at step (412) results in a subsequent test to determine if the first auxiliary thread has completed processing (414). If the response to the test at step (414) is positive, the second auxiliary thread regards the element the head pointer points to as E2 (416) and continues processing at step (426). On the other hand, a negative response to the test at step (414) results in a return to step (408) to determine if the purge flag is set. If the purge flag is set, the processing of the second auxiliary thread proceeds to step (510). If the response to the test at step (412) is negative, the processing of the second auxiliary thread proceeds to step (422). Accordingly, the first part of the processing of the second auxiliary thread is to determine if the head pointer of the entry obtained from the second queue, Q2, is NULL or equal to the last pointer.

Following a negative response to the test at step (404) or a negative response to the test at step (412), the second auxiliary thread regards the element the head pointer points to as E2 (422), and allows the head pointer to point to the element next to the element the head pointer was pointed to (424). Following either of steps (424) or(418), a bean instance is either created or obtained from the instance pool (426). Following step (426), a test is conducted to determine if E2 is an object with a Not Found, For Create, or Remove Requested mark (428). A positive response to the test at step (428) results in attaching Not Found, For Create, or Remove Requested mark to an empty bean instance, respectively, and regarding the attachment as E3 (430). Similarly, a negative response to the test at step (428) results in attaching a Create Requested, Find Requested, or For Find mark (432), respectively, to the bean instance materialized at step (426), initializing content of the bean instance with content of E2, and regarding the attachment as E3 (434). Following completion of steps (430) or (434), the second auxiliary thread retrieves the associative memory, M, with a primary key, PK, taken from E2 (436). Accordingly, the second part of the processing of the second auxiliary thread encompasses creating or obtaining a bean instance from a bean pool.

The third part of the processing of the second auxiliary thread includes processing of the variable E2. The first test is to determine if E2 has a Remove Requested mark attached (450). A positive response to the test at step (450) will result in a subsequent test to determine if the retrieval result has a For Find or For Create mark attached (452). If the response to the test at step (452) is positive, the retrieval result is overwritten with E3 (454). On the other hand, if the response to the test at step (452) is negative, another test is conducted to determine if the retrieval result has a Not Found mark attached (456). A positive response to the test at step (456) results in attachment of a Remove Error mark to the retrieval result (458). Similarly, a negative response to the test at step (456) will result in no retrieval result. E3 is associated with the primary key, PK, and is added to the associative memory, M (460).

If it is determined at step (450) that E2 does not have a Remove Request mark attached, a test is then conducted to determine if E2 has a Create Requested mark attached (462). A positive response to the test at step (462) will result in a subsequent test to determine if the retrieval result has a Not Found or a For Create mark attached (464). If the response to the test at step (464) is positive, the retrieval result is overwritten with E3 (466). On the other hand, if the response to the test at step (466) is negative, another test is conducted to determine if the retrieval result has a For Find mark attached (468). A positive response to the test at step (468) results in a Create Error mark being attached to the retrieval result (470). Similarly, a negative response to the test at step (468) results in no retrieval result, and associating E3 with the primary key, PK and adding it to the associative memory, M (472).

If it is determined at step (462) that E2 does not have a Create Requested mark, a test is then conducted to determine if E2 has a Find Requested mark (474). A positive response to the test at step (474) results in a subsequent test to determine if the retrieval results has a For Find or a For Create mark attached (476). If the response to the test at step (476) is positive, the retrieval results is overwritten with E3 (478). Similarly, if the response to the test at step (476) is negative, there is no retrieval result and E3 is associated with the primary key, PK, is added to the associative memory (480). If it is determined at step (474) that E2 does not have a Find Requested mark attached, a test is conducted to determine if E2 has a Find Mark attached (482). A positive response to the test at step (482) will result in a subsequent test to determine if there is a retrieval result (484). If the response to the test at step (484) is positive, no processing is carried out (486). Note that the retrieval result does not have a Not Found, Create Error, or Remove Error mark attached. If the response to the test at step (484) is negative, there is no retrieval result. E3 is associated with the primary key, PK, and is added to the associative memory, M (480).

If it is determined at step (482) that E2 does not have a For Find mark attached, a test is conducted to determine if E2 has a For Create mark attached (490). A positive response to the test at step (490) will result in a subsequent test to determine if the retrieval result has a Not Found mark attached (492). If the response to the test at step (492) is positive, the retrieval result is overwritten with E3 (494). Similarly, if the response to the test at step (492) is negative, a subsequent test is conducted to determine if the retrieval results has a Created, Removed, For Find, Find Requested, Remove Requested, Create Requested, or For Create mark attached (496). A positive response to the test at step (496) will result in no processing (498). Note that the retrieval result does not have a Create Error or Remove Error mark. If the response to the test at step (496) is negative, there is no retrieval result and E3 is associated with the primary key, PK, and added to the associative memory, M (500).

If it is determined at step (490) that E2 does not have a For Create mark attached, a test is conducted to determine if E2 has a Not Found mark attached (502). A positive response to the test at step (502) results in a subsequent test to determine if there is a retrieval result (504). There may be a case with a Not Found, Created, Removed, For Find, Find Requested, Remove Requested, Create Requested, or For Create mark. If the response to the test at step (504) is positive, no processing is carried out (506). Similarly, if the response to the test at step (504) is negative, E3 is associated with the primary key, PK and added to the associative memory, M (508). Following steps (454), (458), (460), (466), (470), (472), (478), (480), (486), (488), (494), (498), (500), (506), conducted to determine if the purge flag, F2 is set (510). If the purge flag, F2 is set, the purge flag, F2 is cleared and the second auxiliary thread waits until the purge flag, F1, is cleared (512). Following clearance of the first purge flag at step (512) or a negative response to the test at step (510), the second auxiliary thread returns to step (402) for processing. Accordingly, the second auxiliary thread processes E2 and the mark attached followed by processing the first and second purge flags.

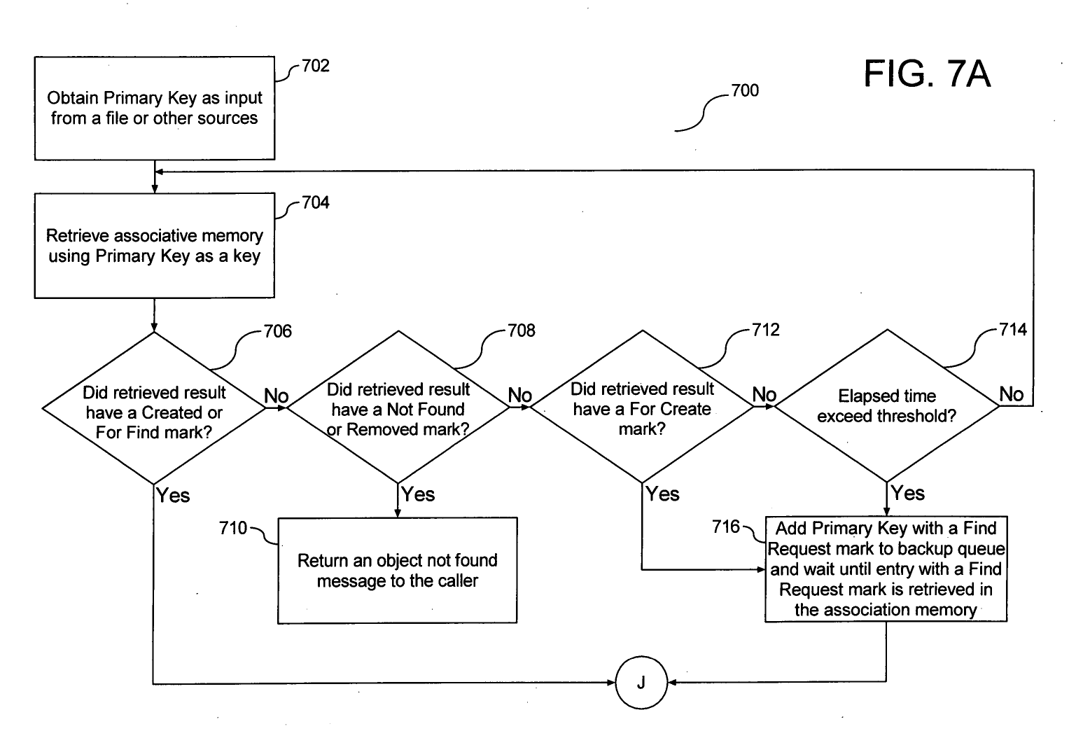

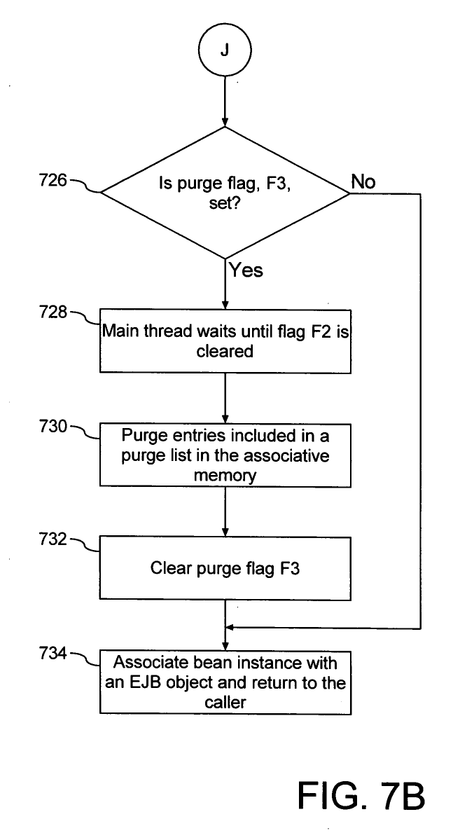

FIG. 7 is a flow chart (700) illustrating the process for retrieval of an entity bean by the main thread. The primary key, PK, is obtained as input from a file or other sources (702), and the associative memory, M, is retrieved using the primary key, PK, as a key (704). Thereafter, a test is conducted to determine if the associative memory retrieved at step (704) has a Created or For Find mark (706). A positive response to the test at step (706) results in proceeding to step (726). On the other hand, a negative response to the test at step (706) results in a subsequent test to determine if the associative memory retrieved at step (704) has a Not Found or a Removed mark (708). A positive response to the test at step (708) results in return of an “object not found” message returned to the caller of the retrieval process (710). On the other hand, a negative response to the test at step (708) results in another test to determine if the associative memory retrieved at step (704) has a For Create mark (712). If the response to the test at step (712) is negative, a test is conducted to determine if the elapsed time for the retrieval has exceeded a threshold time duration (714). If the response to the test at step (714) negative, the process returns to step (704). A positive response to the tests at steps (712) or (714) will result in adding the primary key, PK, with a Find Requested mark to the backup queue and waiting until the entry with a Find Requested mark is retrieved in the associative memory (716). While waiting, if F3 is set, conduct steps (726) to (732), then continue waiting.

Following a positive response to the test at step (706), or step (716), a test is conducted to determine if the purge flag, F3 is set (726). A negative response to the test at step (726) will result in associating the bean instance with an EJB object and returning it to the caller (734). If the response to the test at step (726) is positive, the main thread waits until the purge flag, F2, is cleared (728), and the entries included in the purge list in associative memory, M, are purged (730). The association between the bean instance and the EJB object are removed. If the bean instance has not been updated, it is purged from memory. Similarly, if the bean instance has been updated, the corresponding database entry is updated before the bean instance is purged from memory. If a Remove mark is attached, the data base entry is removed before purging, and if a Create mark is attached, the database entry is created before purging. Following step (730), the purge flag, F3, is cleared (732). Similarly, following a negative response to the test at step (726) or completion of the purging of the flag F3 at step (732), and the bean instance is associated with an EJB object and returned to the caller (734).

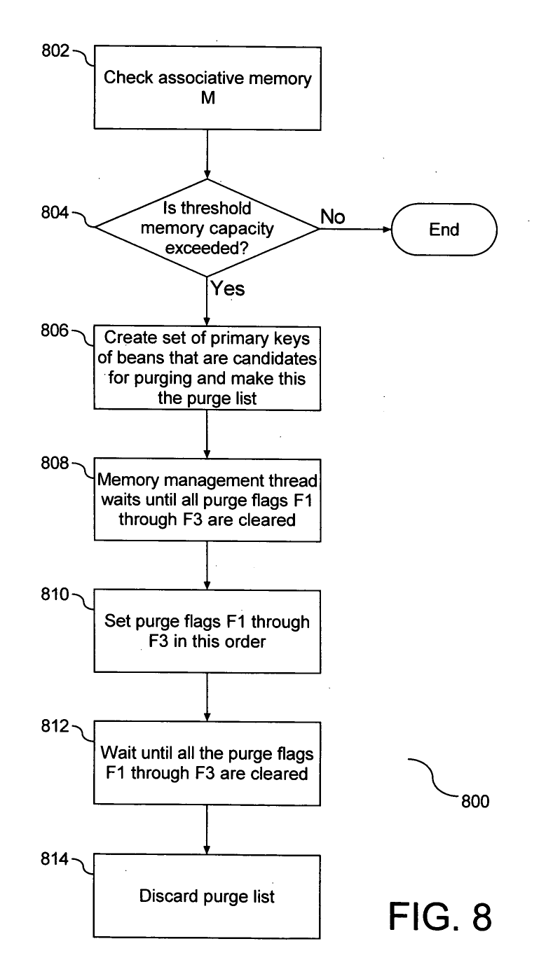

FIG. 8 is a flow chart (800) illustrating the memory management thread. The following steps are conducted periodically with a specific time interval. Initially, the associative memory, M, is checked (802). Thereafter, a test is conducted to determine if the threshold of memory capacity is exceeded (804). A negative response to the test at step (804) will result in completion of purging from associative memory, since the associative memory capacity has not been attained. If the response to the test at step (804) is positive, a set of primary keys of the beans that are candidates are created for purging and this is made into a purge list (806). Following step (806), the memory management thread waits until all of the purge flags, F1, F2, and F3 are cleared (808), and the purge flags, F1, F2, and F3, are set, respectively (810). Following step (810), the memory management thread waits until all of the purge flags, F1, F2, and F3 are cleared (812), and the purge list is then discarded. Steps (802)-(814) are conducted by the memory management thread at periodic intervals. Accordingly, the memory management thread utilizes the purge flags to coordinate purging of primary keys from memory.

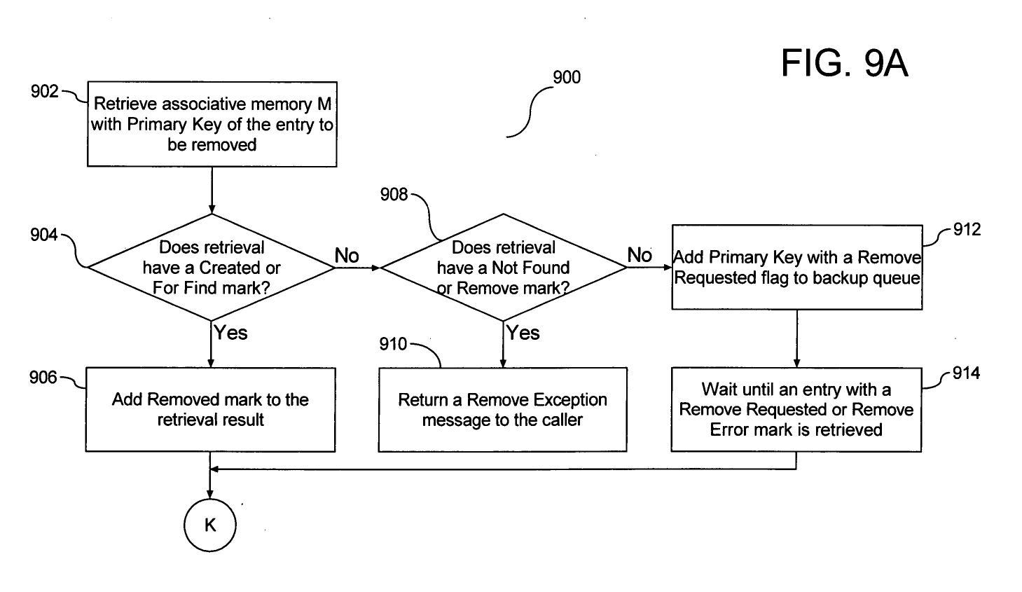

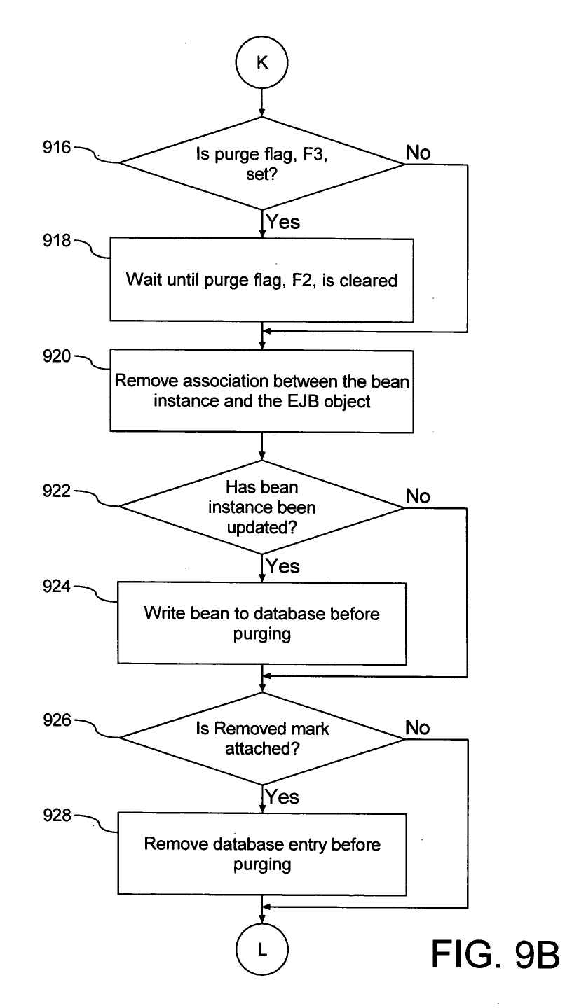

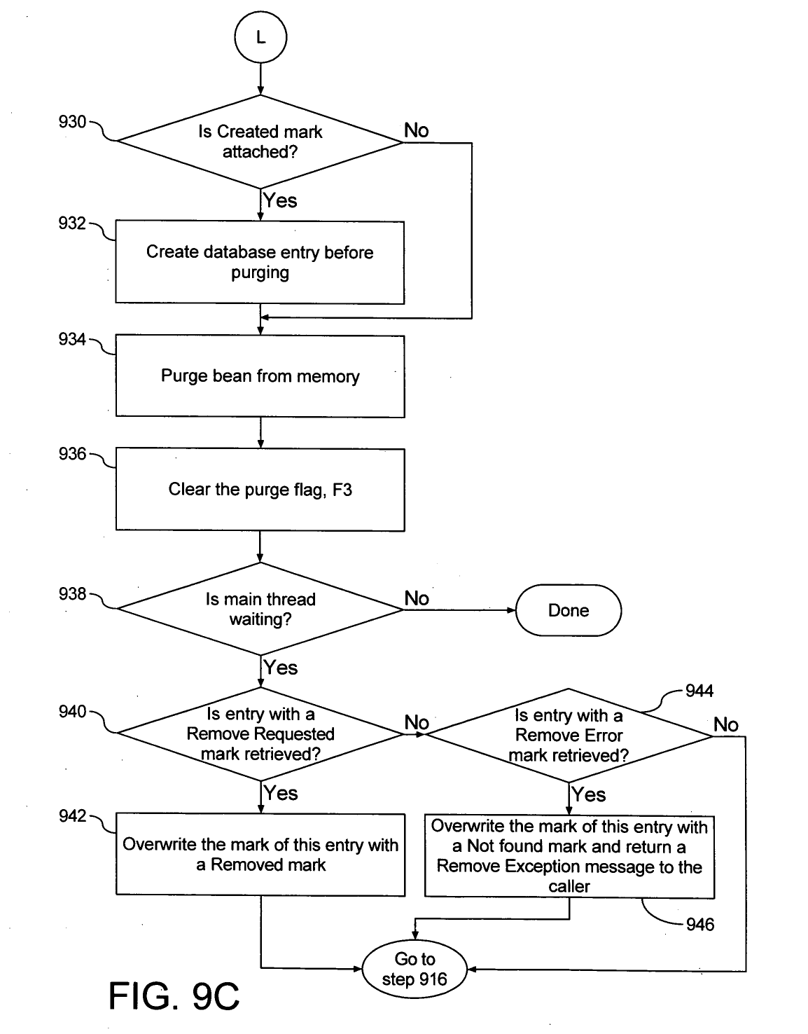

FIG. 9 is a flow chart (900) illustrating removal of an entity bean by the main thread. The associative memory, M, is retrieved together with the primary key, PK of the entry to be removed (902). Thereafter, a test is conducted to determine if the retrieval from step (902) has a Created or For Find mark attached (904). If the response to the test at step (904) is positive, a Removed mark is added to the retrieval result (906). Similarly, if the response to the test at step (904) is negative, another test is conducted to determine if the retrieval from step (902) has a Not Found or Removed mark attached (908). A positive response to the test at step (908) results in returning a Remove Exception message to the caller (910). In contract, if the response to the test at step (908) is negative, the primary key, PK, together with a Remove Requested flag is added to the backup queue (912) and the main thread waits until an entry with a Remove Requested or Remove Error mark is retrieved (914). While waiting, if purge flag F3 is set, conduct step (918), then continue waiting. Following step (906) or while waiting at step (914), a test is conducted to determine if the purge flag, F3, is set (916). If the response to the test at step (916) is positive, wait until the purge flag, F2, is cleared (918). In contrast, if the response to the test at step (916) is negative or following step (918), the entries included in a purge list in the associative memory, M are purged by the steps shown (920)-(928) first, the association between the bean instance and the EJB object is removed (920). A test is then conducted to determine if the bean instance has been updated (922). If the response to the test at step (922) is positive, the bean is written to the database before purging (924). Similarly, if the response to the test at step (922) is negative or following step (924), a test is conducted to determine if the bean has a Removed mark attached (926). A positive response to the test at step (926) will result in removing the database entry before purging (928). Following step (928) or a negative response to the test at step (926) another test is conducted to determine if the bean has a Created mark attached (930). If the response to the test at step (930) is positive, a database entry is created before purging (932). Following step (932) or a negative response to the test at step (930), the bean is purged from memory (934), and the purge flag, F3, is cleared (936). As explained at step (914) the main thread may be in a waiting state. Following step (936), a test is conducted to determine if the main thread is still in a waiting state (938). If the response to the test at step (938) is positive, a subsequent test is conducted to determine if the entry with a Remove Requested mark has been retrieved (940). A positive response to the test at step (940) will result in overwriting the mark of this entry with a Removed mark followed by a return to step (916). Similarly, a negative response to the test at step (940) will result in another test to determine if an entry with a Remove Error mark has been retrieved (944). A positive response to the test at step (944) will result in overwriting the mark of this entry with a Not Found mark and returning a Remove Exception message to the caller (946). Following step (942) or (946) or a negative response to the test at step (944), the main thread returns to step (916). Finally, when it is determined at step (938) that the main thread is not in a waiting state, the process of removing the entity bean is completed.

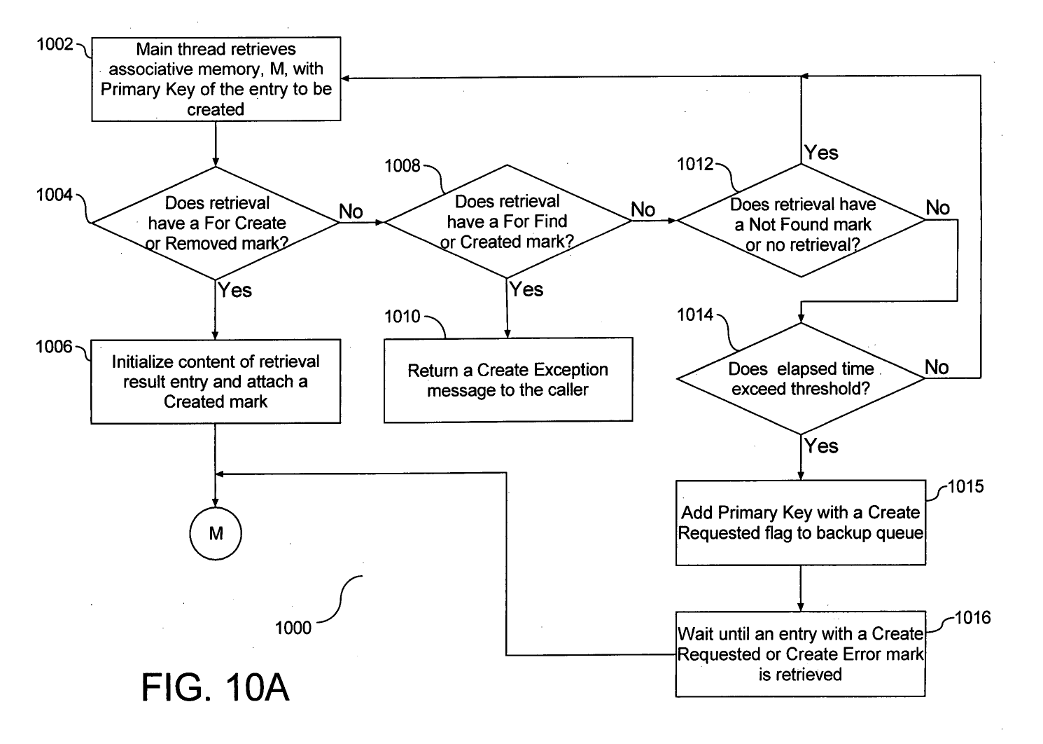

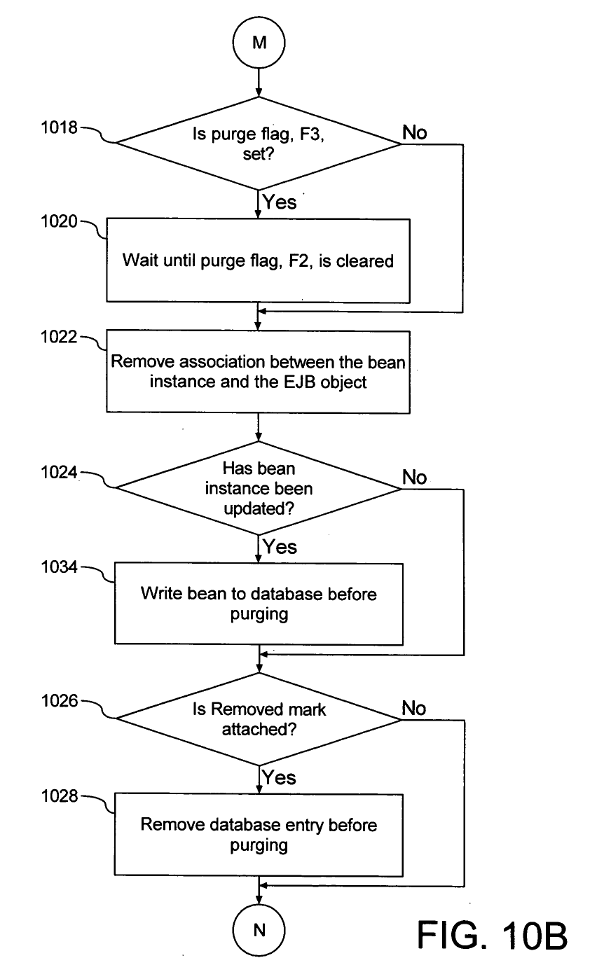

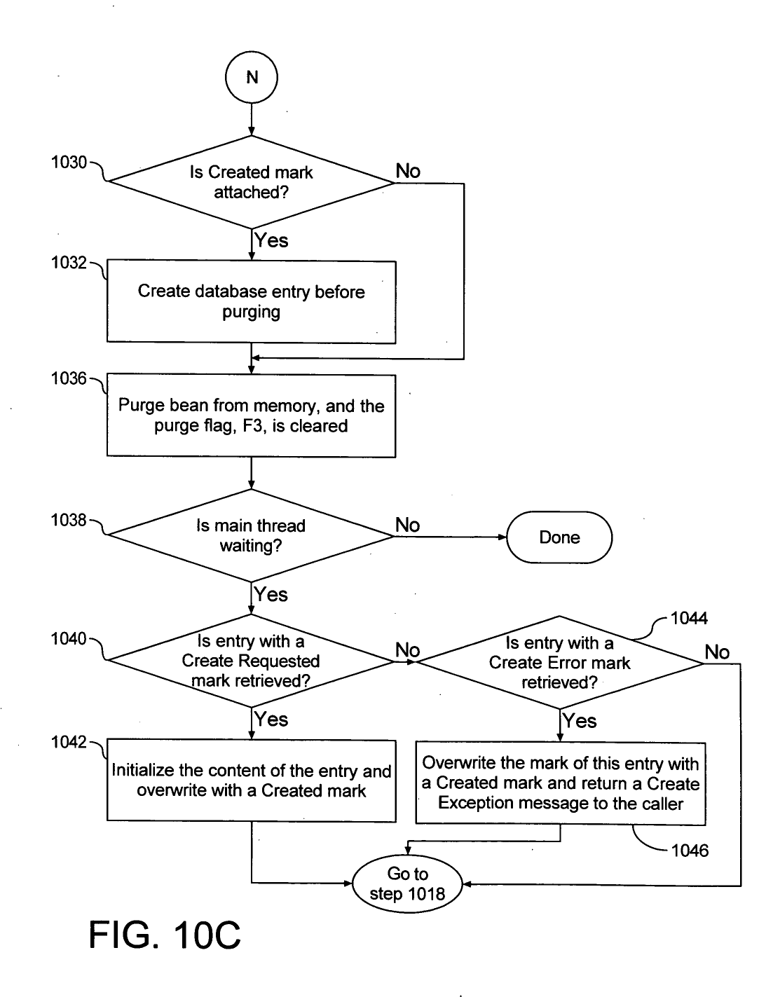

FIG. 10 is a flow chart (1000) illustrating the process for an entity bean creation by the main thread. Initially, the main thread retrieves the associative memory, M, with the primary key, PK, of the entry to be created (1002). Following the retrieval at step (1002), a test is conducted to determine if the retrieval result has a For Create or Removed mark attached (1004). A positive response to the test at step (1004) will result in initializing the content of the retrieval result entry and attaching a Created mark (1006). On the other hand, a negative response to the test at step (1004) will result in a subsequent test to determine if the retrieval result has a For Find or Created mark attached (1008). A positive response to the test at step (1008) will result in returning a Create Exception message to the caller (1010). A negative response to the test at step (1008) will result in another test to determine if the retrieval results has a Not Found mark or if there is no retrieval result (1012). A positive response to the test at step (1012) will return to step (1002), and a negative result at step (1012) will result in another test to determine if the elapsed time has exceeded a threshold (1014). If the response to the test at step (1014) is positive, a primary key, PK, is added with a Create Requested flag to the backup queue (1015) and the main thread waits until an entry with a Create Requested or Create Error mark is retrieved (1016). While waiting, if F3 is set, conduct steps (1018) to (1020), then continue waiting. If the response to the test at step (1014) is negative, it returns to step (1002). Following step (1006) or while the main thread is waiting, a test is conducted to determine if the purge flag, F3, is set (1018). If the purge flag, F3, is set, the main thread waits until the purge flag, F2, is cleared (1020). Following a step (1020) or a negative response to the test at step (1018), the main thread purges entries included in a purge list in associative memory, M, by following steps (1022)-(1028), and (1034). First the association between the bean instance and the EJB object is removed (1022). After step (1022), a test is conducted to determine if the bean instance has been updated (1024). If the response to the test at step (1024) is positive, the bean instance is written to the database prior to purging (1034). Following step (1034) or a negative response to the test at step (1024), a test is conducted to determine if the bean has a Removed mark attached (1026). A positive response to the test at step (1026) will result in removing the bean instance before purging (1028), and a negative response to the test at step (1026) will result in another test to determine if the bean has a Created mark attached (1030). If the response to the test at step (1030) is positive, a bean instance is created before purging (1032). Following step (1032) or a negative response to the test at step (1030), the bean is purged from memory and the purge flag, F3, is cleared (1036).

As explained at step (1016) the main thread may be in a waiting state. Following step (1036), a test is conducted to determine if the main thread is still in a waiting state (1038). If the response to the test at step (1038) is positive, a subsequent test is conducted to determine if the entry with a Create Requested mark has been retrieved (1040). A positive response to the test at step (1040) will result in initializing the content of the entry and overwriting the mark of this entry with a Created mark (1042) followed by a return to step (1018). Similarly, a negative response to the test at step (1040) will result in another test to determine if an entry with a Create Error mark has been retrieved (1044). A positive response to the test at step (1044) will result in overwriting the mark of this entry with a Created mark and sending a Create Exception message to the caller (1046). Following step (1046) or a negative response to the test at step (1044), the main thread returns to step (1018). Finally, when it is determined at step (1038) that the main thread is not in a waiting state, the process of creating the entity bean is completed.

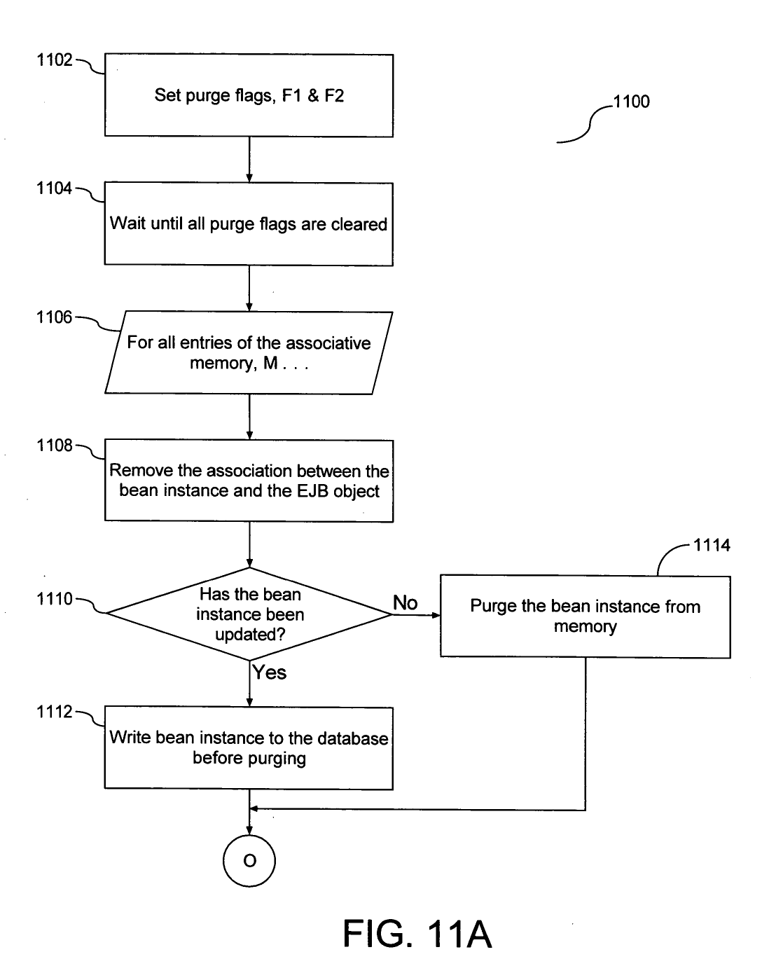

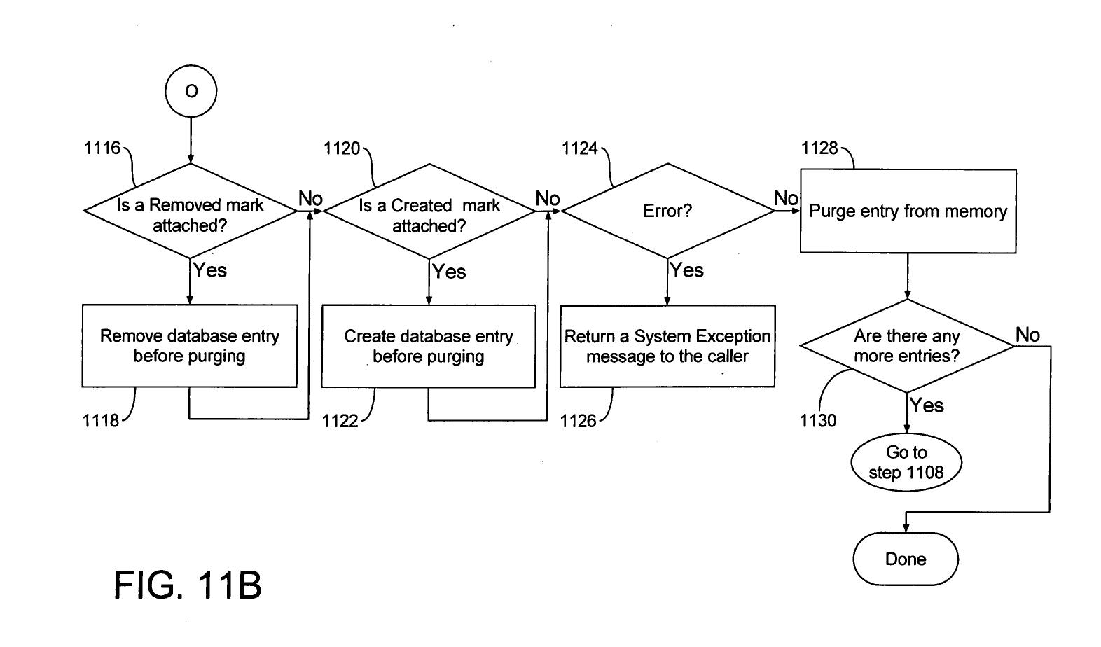

FIG. 11 is a flow chart (1100) illustrating the process of a transaction commitment by the main thread. The purge flags F1 and F2 are set (1102). The main thread then waits until the purge flags are cleared (1104). For all entries of the associative memory, M (1106), removal of the association between the bean instance and the EJB object is conducted (1108). The removal process results in purging of entries. Prior to purging and for each entry, a test is conducted to determine if the bean instance has been updated (1110). If the response to the test at step (1110) is positive, the updated bean instance is written to the database before purging (1112). Alternatively, if the response to the test at step (1110) is negative, the bean instance is purged from memory (1114). Following steps (1112) or (1114), a test is conducted to determine if a Removed mark is attached to the entry (1116). If the response to the test at step (1116) is positive, the database entry is removed before purging (1118). Alternatively, if the response to the test at step (1116) is negative or following step (1118), a subsequent test is conducted to determine if a Created mark is attached to the database entry (1120). A positive response to the test at step (1120) results in creation of a database entry prior to purging. Whereas a negative response to the test at step (1120) or following step (1122), a final test for the entry is conducted to determine if an error associated with the entry has occurred (1124). If the response to the test at step (1124) is positive, a System Exception message is returned to the caller (1126). Following a negative response to the test at step (1124), the entry is purged from the memory M. (1128) and the process determines if there are any more entry in the associative memory, M, (1130). If there are more entries, the process returns to step (1108) for removal and purging. The removal process is completed when all entries in the associative memory have been accounted.

The invention can take the form of a hardware embodiment, a software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk B read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

### Advantages Over the Prior Art

Access patterns of entity beans are utilized to perform speculative creation of bean instances with independent multiple threads. Retrieval of a bean instance is divided into multiple segments for processing, wherein retrieval of the bean is carried out in a speculative manner with an independent thread for each process. This form of threaded processing provides a substantial performance improvement in comparison to non-threaded processing.

### Alternative Embodiments

It will be appreciated that, although specific embodiments of the invention have been described herein for purposes of illustration, various modifications may be made without departing from the spirit and scope of the invention. In particular, it is possible to carry out parallel processing within each thread wherein multiple threads perform the same processing in parallel. For receiving and passing between each step, a multiplexed queue is used and the thread of the step n searches the n^{th} queue group in order. The results of the (m−1)^{th} step group is stored in the same associative memory. At this time, multiple threads that have the same primary key may write, but in this case it is ensured that the contents are always the same and therefore there is no need for synchronization. Furthermore, the invention can be applied to any format of application and it is especially possible to obtain performance increase when used in combination with the optimization of bulk database access. Accordingly, the scope of protection of this invention is limited only by the following claims and their equivalents.

We claim:

1. A method comprising:
dividing data retrieval into multiple pieces of processing with each retrieval to be executed by an independent thread, including at least one auxiliary threads and one main thread;
associating a processing result of each of said auxiliary threads with a primary key and storing said result in a queue of a next auxiliary thread;
storing said results of a final auxiliary thread in associative memory; and
said main thread retrieving said associative memory with an actual primary key.

2. The method of claim 1, wherein said auxiliary threads speculatively process data with estimated primary keys.

3. The method of claim 1, further comprising a first thread retrieving data from a database, associating processing results with a primary key for storage in a queue of a first of said auxiliary threads.

4. The method of claim 1, further comprising adding an estimated primary key from a final auxiliary thread to a backup queue when a time duration of determination of said estimated primary key exceeds a threshold.

5. The method of claim 4, further comprising a first thread monitoring said backup queue and processing said backup queue primary key in place of data from said database.

6. The method of claim 1, further comprising periodically purging data in said associative memory.

7. A computer system comprising:
multiple threads for processing data, said multiple threads including a first thread, at least one auxiliary threads, and a main thread;
a process result of said first thread and each of said auxiliary threads adapted to be associated with a primary key and stored in a queue of a next auxiliary thread;
associative memory adapted to receive a processing result of a final of said auxiliary threads; and
said main thread adapted to retrieve said associative memory with an actual primary key.

8. The system of claim 7, further comprising an estimated primary key adapted to be utilized by said auxiliary threads to speculatively process data.

9. The system of claim 7, wherein said first thread is adapted to retrieve data from a database and associate processing results with a primary key adapted to be stored in a queue of a first of said auxiliary threads.

10. The system of claim 7, further comprising a backup queue adapted to receive an estimated primary key from a final auxiliary thread when a time duration to determine said estimated primary key by said final auxiliary thread exceeds a threshold.

11. The system of claim 10, wherein said first thread is adapted to monitor said backup queue and process said backup queue primary key in place of data from said database.

12. The system of claim 7, further comprising a manager to periodically purge data in said associative memory.

13. An article comprising:
a computer readable medium;
instructions in said medium for dividing data retrieval into multiple pieces of processing with each retrieval to be executed by an independent thread, including at least two auxiliary threads and one main thread;
instructions in said medium for associating a processing result of each of said auxiliary threads with a primary key and storing said result in a queue of a next auxiliary thread;
instructions in said medium for storing said results of a final auxiliary thread in associative memory; and
instructions in said medium for said main thread retrieving said associative memory with an actual primary key.

14. The article of claim 13, wherein said auxiliary threads speculatively process data with estimated primary keys.

15. The article of claim 13, further comprising instructions in said medium for a first thread retrieving data from a database, associating processing results with a primary key for storage in a queue of a first of said auxiliary threads.

16. The article of claim 13, further comprising instructions in said medium for adding an estimated primary key from a final auxiliary thread to a backup queue when a time duration of determination of said estimated primary key exceeds a threshold.

17. The article of claim 16, further comprising instructions in said medium for a first thread monitoring said backup queue and processing said backup queue primary key in place of data from said database.

18. The article of claim 13, further comprising instructions in said medium for periodically purging data in said associative memory.

19. The article of claim 13, wherein the medium is a recordable data storage medium.
